(19) United States
(12) Patent Application Publication
(10) Pub. No.: US 2014/0305828 A1
(43) Pub. Date: Oct. 16, 2014

(54) METHODS AND DEVICES FOR RETAIL THEFT PREVENTION

(71) Applicant: Giovanni Salvo, Rosemere (CA)

(72) Inventor: Giovanni Salvo, Rosemere (CA)

(21) Appl. No.: 14/123,281

(22) PCT Filed: Jun. 1, 2012
(86) PCT No.: PCT/CA2012/000509

§ 371 Date: Jun. 30, 2014

Related U.S. Application Data
(60) Provisional application No. 61/492,668, filed on Jun. 2, 2011.

(51) Int. Cl. G08B 13/189; B65D 25/20

(52) U.S. Cl. CPC G08B 13/1895; B65D 25/20
USPC 206/459.1; 340/568.1

(57) ABSTRACT

A theft prevention device is provided for being mounted to a package housing an item. The device comprises a controller, at least one microphone and an alarm device. The controller provides for identifying at least one predetermined sound signal indicative of unauthorized access into the package. The microphone is in communication with the controller for capturing ambient sound and providing a sound signal indicative of the ambient sound to the controller. The alarm device is in communication with the controller for being controlled thereby. The controller provides for comparing the sound signal indicative of the ambient sound with the sound signal indicative of unauthorized access into the package in order to identify a match and thus activating the alarm device to signal an alarm associated with the match.

### CROSS-REFERENCE TO RELATED APPLICATIONS

The present application requests priority on U.S. Patent Application No. 61/492,668 filed on Jun. 2, 2011 and incorporated by reference herein in its entirety.

### TECHNICAL FIELD

The present disclosure relates to the prevention of theft in retail outlets. More particularly, but not exclusively, the present disclosure relates to methods and devices for preventing retail theft.

### BACKGROUND

Retailers report that shoplifting has a significant effect on their bottom line, a significant amount of inventory disappears to shoplifters. Retail theft costs retailers millions of dollars a day. Retailers seek ways to prevent theft and make recovery possible when merchandise is attempted to be stolen.

There exist of a variety of tags that are mounted on item packages and boxes. These tags include resonating elements that when passed through the frequency emitting gates of a store an alarm is signaled. These tags are based on EAS (Electronic Article Surveillance) technology. Yet, thieves have uncovered ways of removing such tags or simply opening the boxes and packages to retrieve the merchandise.

Accordingly, later improvements include tags with wires that wrap the boxes or packages. A drawback with these known systems is the labor and time costs associated with mounting such devices onto packaging. Significantly slowing down product to floor times and significantly increasing costs. Another drawback is that merchandise presentation is affected since the positioning of the device is not too flexible and the wires diminish the marketing appeal of the packaging artwork and presentation. Another drawback is that that wires do not wrap around well to certain packages, boxes desired to be protected.

There thus remains a need for improvements in retail theft prevention.

### OBJECTS

An object of the present disclosure is to provide methods for preventing retail theft.

An object of the present disclosure is to provide devices for preventing retail theft.

### SUMMARY

In accordance with an aspect of the disclosure there is provided a theft prevention device for being mounted to a package housing an item, the device comprising: a controller for identifying at least one predetermined sound signal indicative of unauthorized access into the package, at least one microphone in communication with the controller for capturing ambient sound and providing a sound signal indicative of the ambient sound to the controller, and an alarm device in communication with the controller for being controlled thereby, wherein the controller provides for: (i) comparing the sound signal indicative of the ambient sound with the sound signal indicative of unauthorized access into the package, (ii) identifying a match in (i), and (iii) activating the alarm device to signal an alarm associated with the match.

In an embodiment, the controller comprises a database having a plurality of predetermined sound signals indicative of unauthorized access into the package, the controller providing for comparing the sound signal indicative of the ambient sound with the plurality of sound signals indicative of unauthorized access into the package and identifying a match between the sound signal indicative of the ambient sound and at least one sound signal of the plurality of sound signals indicative of unauthorized access into the package.

In an embodiment, the controller provides for selectively adding to the database other predetermined sound signals indicative of unauthorized access. In an embodiment, the adding comprises uploading. In an embodiment, the controller provides for downloading the plurality of with the plurality of sound signals indicative of unauthorized access into the package from the database onto another platform. In an embodiment, the controller provides for selecting a given sound signal indicative of the ambient sound based on a predetermined condition set and adding the selected given sound signal to the database as an additional sound signal indicative of unauthorized access into the package. In an embodiment, the controller provides for so activating the alarm so as to produce a plurality of alarm signals, wherein a given alarm signal is associated with at least one given the match. In an embodiment, the alarm comprises a warning signal.

In an embodiment, the at least one predetermined sound signal indicative of unauthorized access comprises a sound signal beneath a predetermined volume threshold. In an embodiment, the ambient sound signal comprises an expected sound signal, wherein the expected sound signal is not matched with the sound signal indicative of unauthorized access into the package.

In an embodiment, controller provides for filtering out the expected sound signals. In an embodiment, the controller provides for determining if a given ambient sound signal is an expected sound signal based on a predetermined condition set. In an embodiment, the ambient sound signal comprises a trigger sound signal, wherein the trigger sound signal is matched with the sound signal indicative of unauthorized access into the package. In an embodiment, the sound signal indicative of unauthorized access comprises a voice sound signal. In an embodiment, the sound signal indicative of the ambient sound comprises a voice sound signal. In an embodiment, the predetermined sound signal indicative of unauthorized access into the package comprises a cutting sound.

In an embodiment, the alarm device is activated by the controller when a match is identified for a predetermined length of time. In an embodiment, alarm device is activated by the controller when a match is identified for a number of predetermined times. In an embodiment, the match is identified for a number of predetermined times within a predetermined given time period.

In an embodiment, the device further comprises a user interface in communication with the controller. In an embodiment, the communication between the user interface and the controller is a wireless communication. In an embodiment, the interface comprises a handheld unit. In an embodiment, the interface provides for configuring the controller. In an embodiment, the interface comprises an input interface. In an embodiment, the interface comprises an output interface.

In an embodiment, the device further comprises a plurality of microphones. In an embodiment, the plurality of microphones is arranged in a closed loop configuration.

In an embodiment, the device further comprises a main body for housing the controller, the at least one microphone and the alarm device. In an embodiment, the main body houses the plurality of microphones.

In an embodiment, the device further comprises an EAS component such as a tag, a marker and the like. In an embodiment, the device further comprises an RFID component such as a tag, a marker and the like. In an embodiment, the device further comprises a GPS. In an embodiment, the device further comprises an emitter in communication with the controller, the emitter providing for detecting muffling or a muffling attempt, the emitter providing for signaling the controller of the detection, wherein the controller provides for activating the alarm device to signal an alarm associated with the detection. In an embodiment, the device further comprises a sensor. In an embodiment the sensor is selected from the group consisting of a motion sensor, a proximity sensor, a metal detector, an acoustic/echo locator and any combination thereof. In an embodiment, the motion sensor is selected from the group consisting of an infrared sensor and a mercury switch. In an embodiment, the device further comprises a spectrum analyzer. In an embodiment, the device further comprises a light capturing element. In an embodiment, the device further comprises an additional device mounted within the package for emitting an additional sound selected from the group consisting of an ultrasound, an intrasound, and an infrasound, wherein the additional sound is captured by the microphone and sent as an additional sound signal to the controller, wherein the controller provides for detecting an interference with the additional sound signal and provides for activating the alarm device to signal an alarm associated with the interference.

In accordance with an aspect of the present disclosure, there is provided a kit comprising: a device selected from the group disclosed herein; and a package sound trigger element for producing a trigger sound when opening the package captured by the microphone, wherein the microphone provides a package opening trigger sound signal to the controller, the package opening trigger sound signal matching the predetermined sound signal indicative of unauthorized access into the package.

In an embodiment, the package comprises a closure, wherein the trigger element is mounted at a junction of the closure and another adjacent portion of the package.

In an accordance with an aspect of the present disclosure, there is provided a theft prevention device for being mounted to a package housing an item or directly on an item, the device comprising: a main body for housing an alarm device and a signaling device in operational communication with the alarm device for signaling an unauthorized movement of the main body thereby activating the alarm device to signal an alarm associated with the unauthorized movement; and wherein when the device is mounted to the packaging or the item, the signaling device provides for signaling the unauthorized movement of the main body therefrom.

In an embodiment, the device further comprises a base for being mounted to the packaging or the item and for releasably receiving the main body thereon. In an embodiment, the unauthorized movement of the main body comprises removing the main body from the base mounted on the packaging or the item. In an embodiment, the unauthorized movement of the main body comprises removing the main body along with the base from the packaging or the item. In an embodiment, the main body comprises an aperture, the signaling device comprises a plunger being movable between a non-signaling position within the main body and an alarm signaling position protruding outwardly of the main body via the aperture. In an embodiment, the plunger abuts the base when in the non-signaling position. In an embodiment, the base comprises an aperture for providing the plunger from protruding outwardly thereof when in the signaling position. In an embodiment, the plunger abuts the packaging or the item when is the non-signaling position. In an embodiment, the main body is snap fitted onto the base.

In an embodiment, the signaling device comprises a light capturing panel being positioned on the main body so as to not receive light when the main body is mounted to the package and to receive light when the main body is removed from the package thereby signaling the unauthorized movement.

In accordance with an aspect of the present disclosure, there is provided a theft prevention device for being mounted to a package housing an item and having a closure for providing access to the item therein when the closure is in the open position and for preventing access to the item therein when the closure is in the closed position, the device comprising: a body assembly comprising one body member for being mounted to the closure and another body member movably connected to the one body member for being mounted on another internal portion of the package other than the closure; and a trigger and alarm assembly mounted to the body assembly for signaling an alarm when the body members are moved away from one another.

In an embodiment, the trigger and alarm assembly comprises an alarm device and a switch operatively connected thereto and an actuation assembly operatively connected to the switch, the switch and the alarm device being housed within one of the body members and the actuation assembly being interposed between the body members for actuating the switch to activate the alarm device for signaling the alarm when the body members are moved away from one another. In an embodiment, the body members are moved away from one another when the closure is moved from the closed position to the open position.

In accordance with an aspect of the disclosure, there is provided a theft prevention device for being mounted to a package enclosing an item comprising: a light capturing panel for being mounted within the package; and an alarm device in operational communication with the light capturing panel for being activated thereby so as to signal an alarm, wherein when the device is mounted to a package, the light capturing panel provides for capturing light entering the package so as to activate the alarm device to signal the alarm.

In an embodiment, the device further comprises a main body having one side mounted on an internal portion of the package and housing the alarm device. In an embodiment, the light capturing panel is mounted on the main body.

In an embodiment, the device further comprises a main body mounted to the package externally thereof in communication with the light capturing panel. In an embodiment, the main body houses the alarm device.

In accordance with an aspect of the disclosure, there is provided a theft prevention assembly comprising: a body assembly for being mounted to a package housing an item and having a closure for providing access to the item therein when the closure is in the open position and for preventing access to the item therein when the closure is in the closed position, the body assembly comprising one body member for being mounted to the closure, another body member movably connected to the one body member for being mounted on another internal portion of the package other than the closure, a resonating body mounted to one of either the body members and an actuator interposed between the body members and movably connected to the resonating body for preventing the resonating body to resonate when impacted by a radiofrequency; and an RF device for emitting a radiofrequency to impact the resonating body, wherein when the body assembly is mounted to the package and when the RF device provides the radiofrequency to impact the resonating body, movement of the closure causes a corresponding movement between the body members thereby moving the actuator away from the resonating body allowing the resonating body to be resonated by the impacting radiofrequency so as to produce a frequency indicative of unauthorized access into the package.

In an embodiment, the RF device is mounted to the package.

In accordance with an aspect of the present disclosure, there is provided a method for preventing the theft of an item within a package comprising: (a) identifying at least one predetermined sound signal indicative of unauthorized access into the package; (b) capturing ambient sound; (c) providing a sound signal indicative of the captured ambient sound; (d) comparing the sound signal indicative of the ambient sound with the sound signal indicative of unauthorized access into the package; (e) identifying a match in (d); and (f) producing an alarm associated with the match.

In accordance with an aspect of the disclosure, there is provided a theft prevention management system comprising: a remote controller; and a plurality of devices as disclosed herein, wherein each device comprises a respective device controller in communication with the remote controller, wherein the remote controller receives information from each respective device controller.

The term “package” or “packaging” also includes without limitation whatsoever to the broad definition thereof a box of any type of configuration or any other type of full or partial enclosure for housing, enclosing or otherwise mounting an item therein or thereto as is known in the art made by any type of material.

The term “article(s)” also includes package, packages, and items depending on the use of a particular device, or assembly of devices disclosed herein.

Other objects, advantages and features of the present disclosure will become more apparent upon reading of the following non-restrictive description of illustrative embodiments thereof, given by way of example only with reference to the accompanying drawings.

### BRIEF DESCRIPTION OF THE DRAWINGS

In the appended drawings:

FIG. 1 is a perspective view of a theft prevention device for articles in accordance with a non-restrictive illustrative embodiment of the present disclosure;

FIG. 1a is a schematic view of a theft prevention device for articles in accordance with a non-restrictive illustrative embodiment of the present disclosure;

FIG. 2 is an exploded perspective view of the device of FIG. 1;

FIG. 3a is a lateral view of the device of FIG. 1 mounted to a package;

FIG. 3a is a schematic representation of the plunger switch of the device of FIG. 1 when mounted to a package in accordance with non-restrictive illustrative embodiment of the present disclosure;

FIG. 3b is a lateral view of the device of FIG. 1 when removed from a package;

FIG. 3bb is a schematic representation of the plunger switch of the device of FIG. 1 when removed from a package in accordance with a non-restrictive illustrative embodiment of the present disclosure;

FIG. 4 is a top plan view of a sound triggering device in accordance with a non-restrictive illustrative embodiment of the present disclosure;

FIG. 4a is a schematic view of a box comprising a triggering device in accordance with a non-restrictive illustrative embodiment of the present disclosure;

FIG. 5 is a lateral view of a theft prevention device for articles in accordance with another non-restrictive illustrative embodiment of the present disclosure mounted to a bottle surface;

FIG. 6 is a perspective view of a theft prevention device for articles in accordance with yet another non-restrictive illustrative embodiment of the present disclosure mounted within a package;

FIG. 7 is a top perspective view of a theft prevention device for articles in accordance with a further non-restrictive illustrative embodiment of the present disclosure;

FIG. 8 is a lateral view of a theft prevention device for articles in accordance with still a further non-restrictive illustrative embodiment of the present disclosure;

FIG. 9 is a perspective view of a theft prevention device for articles in accordance with yet a further non-restrictive illustrative embodiment of the present disclosure mounted within a package;

FIGS. 10 and 11 are schematic representations of the trigger switches of the devices of FIGS. 7, 8 and 9 in accordance with a non-restrictive illustrative embodiment of the present disclosure;

FIG. 12 is perspective view of a theft prevention device for articles in accordance with still yet another non-restrictive illustrative embodiment of the present disclosure mounted to a package in a first position;

FIG. 13 is a perspective view of the device of FIG. 12 mounted to a package in a second position;

FIG. 14 is a perspective bottom view of a main body of a theft prevention device for articles in accordance with still yet another non-restrictive illustrative embodiment of the present disclosure;

FIG. 15 is perspective top view of a base of the device of FIG. 14;

FIG. 16 is a perspective view of a removal device for the base of a theft prevention device for articles in accordance with a non-restrictive illustrative embodiment of the present disclosure;

FIG. 17 is a schematic diagram of a theft prevention management system in accordance with a non-restrictive illustrative embodiment of the present disclosure;

FIG. 17a is a perspective view of a theft prevention device in accordance with a non-restrictive illustrative embodiment of the present disclosure;

FIG. 18 is a perspective view of a theft prevention device in accordance with a non-restrictive illustrative embodiment of the present disclosure;

FIG. 19 is a schematic representation of the theft prevention device of FIG. 18; and

FIG. 20 is an example of a states diagram of the operational states of the theft prevention device in accordance with a non-restrictive illustrative embodiment of the present disclosure.

### DETAILED DESCRIPTION OF ILLUSTRATIVE EMBODIMENTS

Generally stated, non-limitative illustrative embodiments of the present disclosure provide theft prevention devices that can be mounted to packaging having therein merchandise to be protected from theft. The theft prevention devices activate an alarm if an attempt is made to open the packaging or to remove the theft prevention device from the without authorization and/or prior to purchase.

Generally stated there is provided a variety of devices and methods for preventing theft in retail outlets. In one embodiment, the devices include a main housing body which includes a controller, for example the inner electronics, circuit board and the like. In an embodiment, the device is mounted to packages or boxed merchandise for creating a possible alarm condition ‘In-store” if the items inside the packaged boxes are removed or attempted to be removed without authorization and/or prior to purchase. In an embodiment, the devices mounted directly onto the item to be protected instead of the box. In an embodiment, the device includes two separate components, one of which is not mounted on the item or packaging but strategically positioned within the premises in which the items are found. In an embodiment, the device is not mounted on the item but strategically positioned to capture a signature sound that signals an alarm.

The alarm is activated if the box is attempted to be opened without said prior authorization. This box protection unit is equipped with sound recognition technology.

In an embodiment, the devices can also be used without the sound recognition technology to protect a non-boxed item.

In an embodiment, the main body is mounted to a base support via a snap fit and via the use of a pin mounted to a box and sealed thereto. For flat surfaces a flat base is used and for curved surfaces a base with a curved bottom is used. In an embodiment, the bases are provided with an adhesive material to adhere to the box containing the protected item. As such, a protective film covers the underside of these bases. In an embodiment, the main body can also be mounted to the packages or boxes directly, without an adhesive.

In an embodiment, the base provides for receiving the main body in a “snap fit”. The foregoing facilitates tagging costs and reduces labor costs since there is no wire to wrap around the box as with the Spider Wrap™ or similar versions. In an embodiment, the base is applied at the source where labor costs are low so that all that is required at the store is to “snap in” the main body or unit. Of course, the “source” can be at any point in the supply chain. In an embodiment, the base is applied at the store or like retail level.

In an embodiment, the main body comprises an upper lip for being removed with a tool.

In an embodiment, the main body houses a plunger, in one non-limiting example this plunger is a plunger type micro switch and a PCB (powered by a power source such as a lithium battery for example) which will permit an alarm to be signaled when the plunger is released without prior validation. More particularly, the PCB permits a temporary deactivation during a predetermined time frame. Also, when a deactivated unit is applied or “snapped in” the unit automatically after a few seconds (programmable seconds) to go into “alarm mode”. This can be convenient in preventing false alarms by authorized personnel from touching the plunger. In an embodiment, a hand held remote control can be used to modulate including activate/deactivate the controller within the main body.

In an embodiment, there is a plurality of alarms. In one example, there are six alarm levels depending on the device.
Alarm 1: an alarm is signaled if the device is removed prior to validation/deactivation triggered by the plunger.
Alarm 2: an alarm is signaled on the Electronic Article Surveillance (EAS) or RFID system by an internal ferrite or circuit (mainly 8.2 mhz and 58 khz, and other EAS frequencies and including RFID emerging frequencies in the 13 mhz and 900 khz frequency range but not limiting to any EAS/RFID frequency) inside the main body.
Alarm 3: the device is activated by the EAS and/or RFID transmitter and/or transceiver.
Alarm 4: a Radio Frequency Identification (RFID) signal is transmitted from the device to a remote receiver which will produce an alarm condition and produce optional encoded product information simultaneously if desired if removed without authorization.
Alarm 5: infrared (IR) pairing technology will create an alarm if a IR encoded remote or IR encoded deactivation unit is not used with a “paired” IR inside the main unit during the authorized removal process.
Alarm 6: a constant active RFID zone communication between the main body and/or solar device will make it possible to protect specific zones in retail shops, not only the exits. When a main unit leaves the zone an alarm is triggered. The communication requires no pedestals so it creates a high level seamless protection convenient for certain retailers.

In an embodiment, the device uses at least one of the above alarms. In an embodiment, the device uses any combination of two or more of the above alarms.

In an embodiment, the device includes a sleep mode function that is automatically activated when there is movement of the device. A motion sensor is therefore incorporated within the circuitry of the device controller.

In an embodiment, the controller comprises sound recognition technology. In an embodiment, the controller is a PCB. In an embodiment, the controller is a processor.

As is known in the art, sound recognition enables devices to listen and understand their surrounding ambient auditory environment. This technology is at the basis of various types of audio sensing which can find applications in surveillance, factory automation, entertainment media analysis, and other domains where audio feedback can be critical. As is known in the art sound recognition includes speech recognition as well as generalized sound recognition. Therefore, sound recognition includes any type of technological framework capable of working with any type of sound regardless of its nature.

The theft prevention devices disclosed herein take advantage of sound recognition devices known in the art of a convenient size and configuration for the purposes described herein.

Sound recognition technology recognizes certain predetermined sounds (referred to herein as “trigger sounds”). Once a match is made, an associated alarm is signaled. The alarm only triggers once the sound is captured. In some cases the sound must be captured more than one time to activate a trigger. Programming is possible through the USB port to be able to choose the different sounds and/or words wanted. A sensitivity setting allows the number of sound captures. This avoids unwanted “false” alarms.

In an embodiment, a motion capture device, such as for example a camera, in communication with the main body controller provides for determining the presence and in certain instances the distance between a human subject or an object and the devices herein thereby limiting false alarms. The above system is of course used in conjunction with the sound technology herein so as to avoid false alarms when a trigger sound is captured without the presence of a potential perpetrator at the vicinity of the target item. In an embodiment, a camera can be also be used for object recognition as is known in the art.

In an embodiment, a programming switch is turned on to activate the learning mode. The learning mode can record new sounds not previously recognized by the controller.

In an embodiment, a separate unit comprising a controller can also be used as a sound collector for uploading sounds or sound signals to the devices herein.

In an embodiment, the device provides for listening to ultrasounds or intrasounds or infrasounds which will be transmitted from devices inside packaging if unauthorized entry is attempted (e.g silent alarm, radar etc.). These sounds are captured by another remote device which triggers the alarm.

In an embodiment, the controller provides for increased security. In an embodiment, the foregoing is provided by generating an alarm when the main unit (or body) is muffled or attempted to be muffled. This is accomplished by listening to the ambient noise by sending out several pulses over milliseconds. When a thief covers the device with aluminum foil or their hand, for example, the ambient noise will change dramatically so that the unit will recognize when some ambient sounds are no longer present. A sensitivity setting allows the user to program how many “ambient sounds” gone missing it will take to trigger the alarm.

In an embodiment, to further reduce false alarms, a sensitivity setting provides to set the number of times within a specified time period that the sound is produced.

In an embodiment, the present device includes a Velcro™ strip inside the packaging.

In an embodiment the hook-and-loop device includes two strips of Velcro™ on with the hook-and-loop fabric formed thereon in a contiguous fashion the other with predetermined empty zones to provide a distinctive predetermined trigger sound that is not confused by the present system with another similar and ambient “tearing sound”.

In an embodiment, an option for reducing false alarms “field units” is provided. In an embodiment, the controller has an intelligence gathering function using sound recognition which comprises a listening device to capture a variety of ambient sounds and electronically add these sounds captured to a separate database. The controller grows in intelligence in its surrounding environment. These sounds are taken back from the field where a triage is performed. The “ambient sounds” are then separated into new “trigger sounds” (a new Velcro™ sound wave or plastic wrapping sound wave, for example) and non-trigger sounds (regular background noise). These new sounds can be downloaded using the USB-type port for example, from the previously mentioned separate unit. Ultrasounds can also be added for increased security.

In an embodiment, there is provided an Intelligence Mode comprising data analysis performed by the controller to determine if a sound signal should be associated with an alarm condition or not. In an embodiment, one condition is to determine if a captured sound signal matches at least one predetermined sound signal indicative of unauthorized access into the package such as pre-recorded box opening signature, in an embodiment the captured sounds signature must match the predetermined indicative sound signature within a certain range or percentage (Condition 1). In an embodiment, another condition is that the sound must be captured and recognized more than once (Condition 2). In an embodiment, another condition is that the sound is not a close match to any “ambient” sound recorded during the learning mode (Condition 3). In an embodiment, another condition is that the Condition 3 is validated several times (Condition 4). In an embodiment, another condition is that the ultrasounds, infrasounds or intrasounds that were present during learning mode must be present for the Condition 3 and Condition 4 to take effect (Condition 5). In one embodiment, the various conditions previously described are cumulative. In another embodiment, the various conditions are not cumulative. In one embodiment, one, two, three, four or five conditions are needed. In one embodiment, any combination of the previously described conditions is provided.

In another embodiment, the present device is mounted within the box and does not include sound recognition technology but rather light capturing technology otherwise known as a solar panel, thus when the flap or other portion of the package is opened during unauthorized retrieval of the packaged item, light enters the box and activates the device to signal an alarm. In an embodiment, the device comprises all or some of the six alarms mentioned above. The device could be used as a stand alone solution or in conjunction with the main unit (or body) described above.

In an embodiment, the present device is mounted within the packages and includes two separate bodies, one body comprises the main body which triggers the alarm, the other body is an anchor mounted within the internal face of the flap cover or any other internal portion of the box and operatively connected to the main body, so that when the flap or any other said portion of the box is opened without authorization, the anchor body is moved along with the flap during the opening process thereby actuating the main body to signal an alarm.

Of course, deactivation is necessary to ensure that an alarm is not signaled when customers have purchased the package. In one embodiment, the device inside the package is removed. A variety of remote control devices can be used to configure the controllers herein or for input and/or output of date as is known in the art.

Mounting of any of the components or bodies of the devices herein can be provided by a variety of ways known in the art including without limitation adhesives, magnets and the like. Of course, mounting also includes without limitation the broad definition thereof whatsoever, resting one part on another or positioning thereon or thereto or therein.

The devices and methods of the disclosure can also be used for other security or theft prevention apparatuses/devices.

With reference, to the appended Figures, non-restrictive illustrative embodiments will be herein described so as to further exemplify the disclosure only and by no means limit the scope thereof.

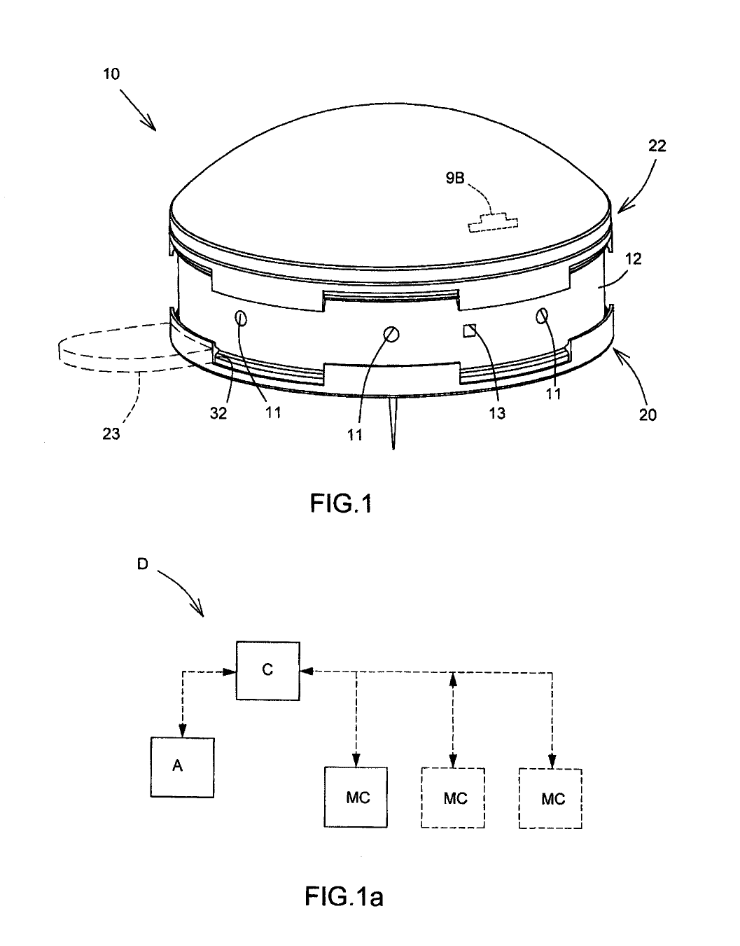

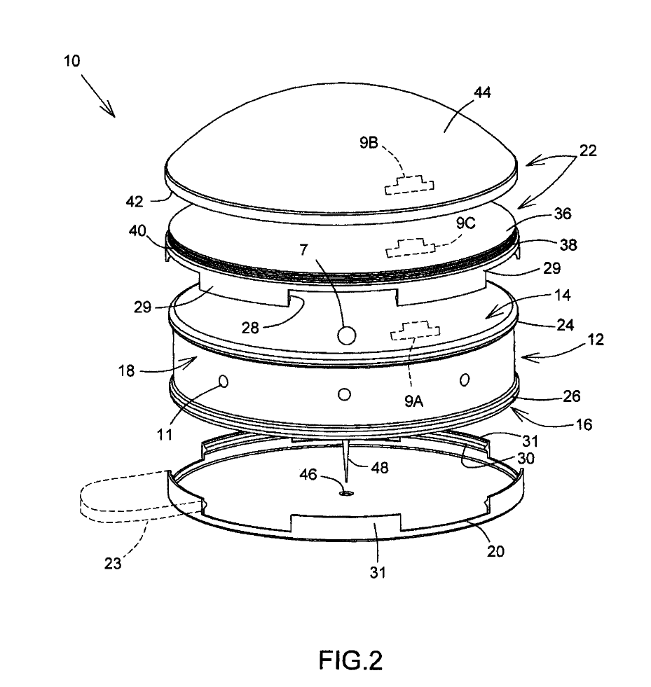

FIGS. 1, 2 to 3bb show device 10 in accordance with an illustrative embodiment of the present disclosure. The device 10 includes a main housing body 12 for housing a controller including a security tag or another EAS device therein as is known in the art. Therefore, if the main housing body 12 is not removed from the article on which it is positioned or otherwise deactivated by the salesclerk at the checkout, a detection system at the exit of the store detects the tag and sounds an alarm. Thieves will be motivated to attempt to defeat this system by removing the main housing body 12 from the article so that the alarm at the exit is not sounded and the article is successfully stolen. As such, the main housing body 12 comprises an alarm system therein for being sounded when removing or attempting to remove the device 10 or the main housing body 12 from an article.

In an embodiment, the main housing body 12 includes sound recognition technology further described below.

More particularly and as schematically shown in FIG. 1A, a device, generally denoted D can include the configuration of device 10 for example or of other embodiments. Device 10 is mounted to a package housing an item therein. The device D comprises a controller C for identifying at least one predetermined sound signal indicative of unauthorized access into the package. The device D further includes at least one microphone MC or a plurality of microphones MC in communication with the controller C for capturing ambient sound and providing a sound signal indicative of the ambient sound to the controller C. The device further includes an alarm device A in communication with the controller C for being controlled thereby. The controller provides for comparing the sound signal indicative of the ambient sound with the sound signal indicative of unauthorized access into the package. The controller then identifies a match of the foregoing and activates the alarm device to signal an alarm associated with the aforementioned match. In an embodiments the components C, A and MC are not mounted within a single body (unit or housing etc.) but separately to the package and in communication with each other by wireless communication, wire communication and the like as is known in the art.

Accordingly, when device 10 is configured as per device D, the main body 12 includes holes 11 which provides for allowing the microphones MC situated therein to receive external sounds as well as an alarm to be emitted therethrough. Optionally, the main body 12 also includes an infrared sensor 13 for motion detection and/or IR security. The main housing body 12 includes top and bottom faces 14 and 16, respectively in a circular median wall 18 therebetween. The bottom face 16 is mounted to a base 20 and the top face 14 optionally receives a cap 22.

In this example, the base 20 comprise a circular configuration which provides for greater security as it cannot be swiveled to the edge of the article. The device 10 including the main body 12, the base 20 and the cap 22 can be provided in a variety of convenient configurations and sizes. In an embodiment, the cap and base are optional.

The base 20 may be adhered to an article or package 13 such a box via a variety of adhesive substances. In this way, the main body 12 may simply be mounted or removed from the base 10 without having to tear the base 12 away from the package. This is convenient as the main body 12 itself does not have to be directly mounted via an adhesive onto the package or article. In an embodiment, a tab 23 extends from the base 12 to provide leverage for removing the base 12 from the article against the adhesive or other mounting force.

In another embodiment, the device 10 includes the main body 12 only and this body is directly mounted to the article via an adhesive or another mounting element. In an embodiment, the device 10 comprises a main body 12 mounted to a base 20 without a cap 22 or other covering.

The top and bottom faces 14 and 16 of the main housing body 12 define top and bottom ridges or lips 24 and 26 for respectively mating with the top teeth 28 (formed on the inner wall of side flaps 29 extending from the cap 22) and the bottom teeth 30 of the base 20 (formed on the inner wall of side flaps 31 extending from the base 20). More specifically, the top ridge 24 is snap fitted within the grooves 32 defined by the top teeth 28 and the bottom ridge 26 is snap fitted within the grooves 34 defined by the bottom teeth 30.

In an embodiment, the main body includes light emitter 7 for emitting a light alarm is as known in the art.

In an embodiment, the main body includes an image capturing element 8 for object recognition such as a camera.

Cap 22 can also be a modular piece which can include new technology for future upgradability for growing features comprising one or more of the various features of the various embodiments disclosed herein.

In an embodiment, the main body 12 includes a connector 9A for receiving another device with a controller or another sensor thereby providing upgradability. As such, the cap 22 can include a connector that connects with connector 9A to add additional technology. In another embodiment, one or more similar main bodies 12 can be added and interconnected via their connectors. As such, the device of the present disclosure provides for growing features comprising one or more of the various features of the various embodiments disclosed herein. Therefore, a variety of devices, including cables as is known in the art can be added to any component of any of the devices disclosed herein including the base by providing convenient sockets or connecting elements.

The foregoing configuration provides the main body 12 to slidingly engage both the cap and base and thereby rotate there between. Thus making it difficult to rotate the main body to the edge of the box and remove the main body 12 from the package it is mounted to as previously described above.

The cap 22 includes a receding portion 36 at the top face 38 thereof including thread elements 40 so as to mutually interface with corresponding threaded elements 42 of a dome-shaped cover 44. The dome shaped cover 44 can be made of translucent material so as to insert a logo and the like between the cover 44 and the cap 22.

The top face 38 and the dome shaped cover can optionally include connectors 96 and 9C similar to the connector 9A discussed above. Connectors 9A, 9B and 9C can be USB connectors, antenna connectors and the like as is known in the art.

The base 20 includes a central opening 46 for receiving therethrough a bottom plunger pin 48 extending from the bottom face 16 of the main body 12 if the device 10 is removed from a package. The underside bottom face 49 includes an adhesive for adhering to the package as previously described above.

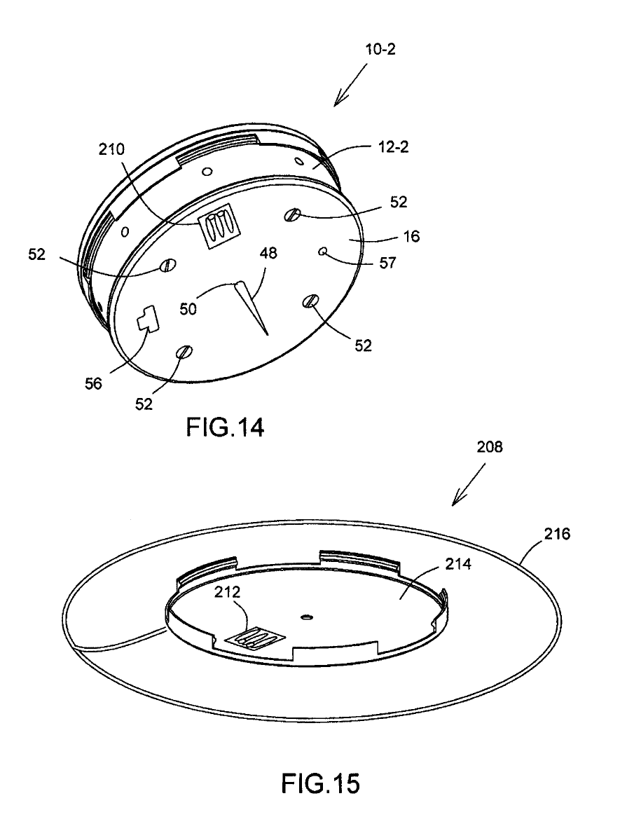

Turning now to FIG. 14 which shows a device 10-2 in accordance with another illustrative embodiment. Device 10-2 includes many of the features of device 10, certain of which will be discussed below with reference to the bottom face 16 of the main body 12.

The bottom face 16 includes an aperture 50 for receiving the plunger pin 48 therethrough as well as four screws 52 for removing the bottom cap 54 and accessing the internal contents of the main housing body 12 for battery replacement and servicing. An opening 56 provides for receiving a USB-type plug for the controller in order to add data thereto via a separate computer unit. A smaller hole 57 provides for filling the internal contents with epoxy so as not to be filled again in order to be deactivated by a potential thief.

In an embodiment, the device 10 comprises the main body 12 for housing an alarm device which can include a switch, a sound generator and an alarm emitter to give but one non-limiting example. The main body also includes a signaling device in operational communication with the alarm device. In one non-limiting example this is provided by the switch. In one non-limiting example, the signaling device is a plunger. In one non-limiting example, the plunger is a pin. In another non-limiting device the signaling device is a solar or light panel. The signaling device provides for signaling a unauthorized movement of the main body 12 thereby activating the alarm device to signal an alarm associated with the unauthorized movement. The base receives the main body 12 and is mounted to the packaging or item. Therefore, when said device 10 is mounted to the packaging or the item, the signaling device provides for signaling the unauthorized removal of the main body 12 therefrom.

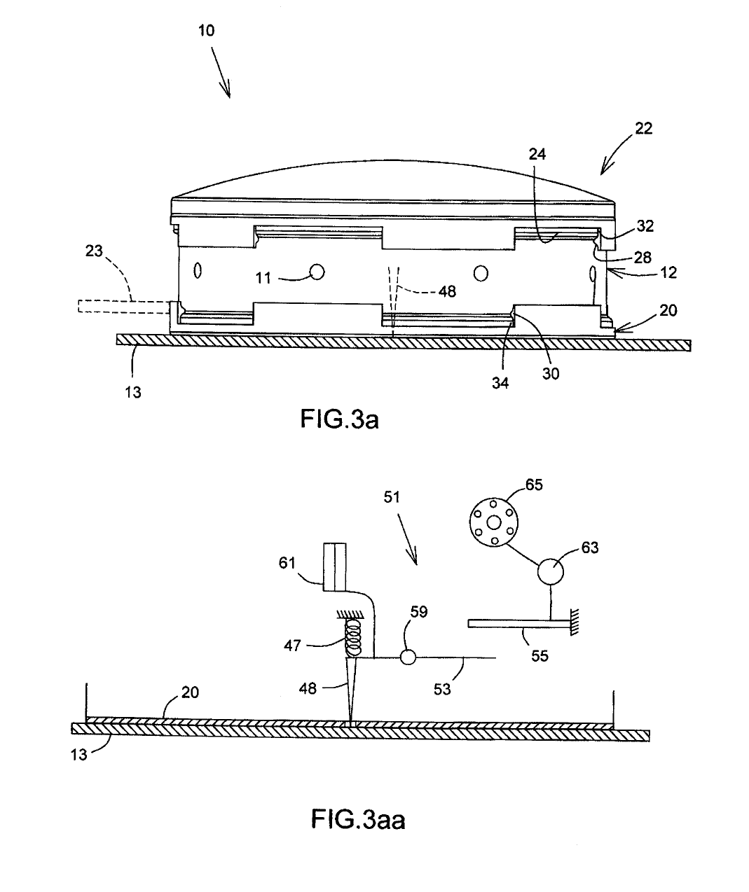

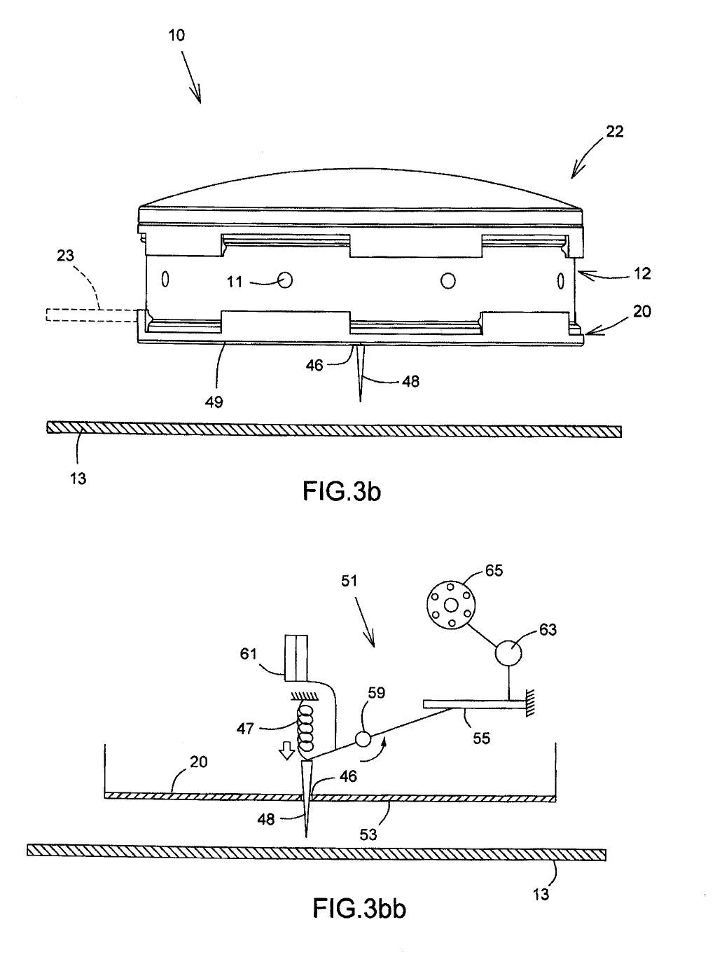

With reference to FIGS. 3a, 3aa, 3b and 3bb, the plunger alarm system of device 10 will now be described in accordance with a non-restrictive illustrative embodiment.

The main body 12 is shown snap fitted to the base 20 that in turn is mounted to the article or package 13. The plunger pin 48 is downwardly biased to slide through apertures 50 and 46. In one embodiment, this bias is provided by the weight of the plunger, in another embodiment is provided by a biasing element such a spring or another deformable and resilient element generally denoted as 47. In this case, given the fact that device 10 is mounted to a package, the tip or free end of the plunger pin 48 abuts the package 13, stopping it from falling further and as such is in a first non-signaling position housed within the main body 12 as shown in FIGS. 3a and 3aa. The plunger pin 48 is in communication with a switch 51. In one embodiment, the switch 51 comprises a pair of conductive switch elements 53 and 55. Element 53 is in communication with the plunger pin 48 and is movable therewith by way of a pivot 59 and with a power source 61. Element 55 is in communication with a sound generator 63 which is in communication with an alarm 65.

When the main body 12 is removed without authorization from the package either with or without the base 20, the package 13 no longer interferes with the plunger pin 48 and as such the plunger pin 48 falls or is pushed outwardly of the main body 12 towards the alarm signaling position as shown in FIGS. 3b and 3bb, thereby causing the switch element 53 to pivot and contact switch element 55. When closing the switch 51, the power source activates the sound generator 63 signaling the alarm 65.

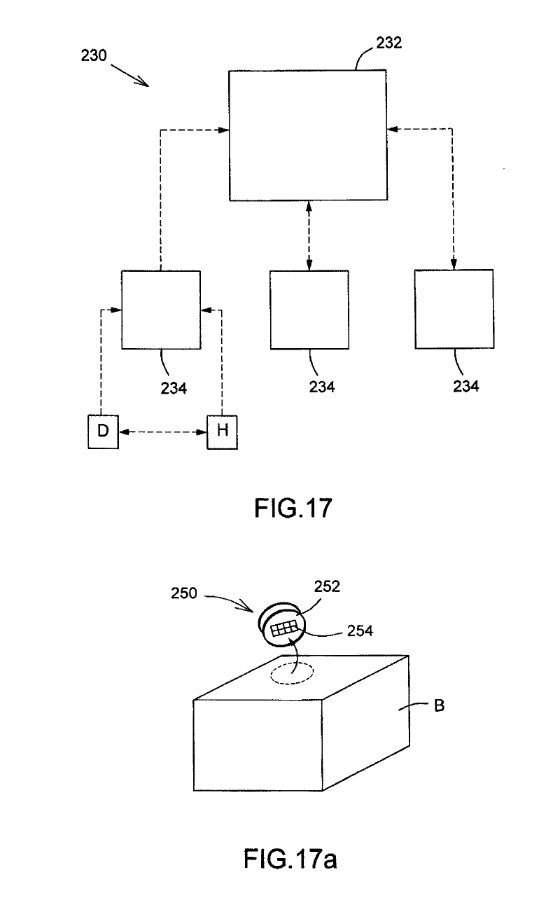

FIG. 17a shown another embodiment of a theft prevention device 250 using a signaling device 254. In this example, the device 250 comprises a circular body structure having on its underside 252 a solar or light panel 254 that acts as a signaling device. When the device 250 is mounted to the box B, the underside 252 interfaces with a box B surface and prevents the solar or light panel 254 from receiving light. Once the device 250, the panel 254 will be exposed to light thereby actuating a switch as is known in the art to activate an alarm device which will signal an alarm associated with the unauthorized movement of the device 250 (which constitutes in this example, a single main body).

As mentioned above and as will be detailed further below, the main body 12, in accordance with a non-restrictive illustrative embodiment, comprises sound recognition technology.

In another embodiment, the device 10 of FIG. 1 is not a sound recognition device but sounds off an alarm when the perpetrator attempts to remove it from the box or package 13. The adhesive between the device 10 and package 13 makes it difficult to remove the base 20 therefrom. Furthermore, the main body 12 swivels between the cap 22 and the base 20, or simply within the base 20. The foregoing frustrates the thief's attempts to remove the main body 12 from the package 13. The foregoing also causes the thief to make a variety of sounds when pulling, rubbing, twisting, cutting and the like in order to remove the main body 12 from the package.

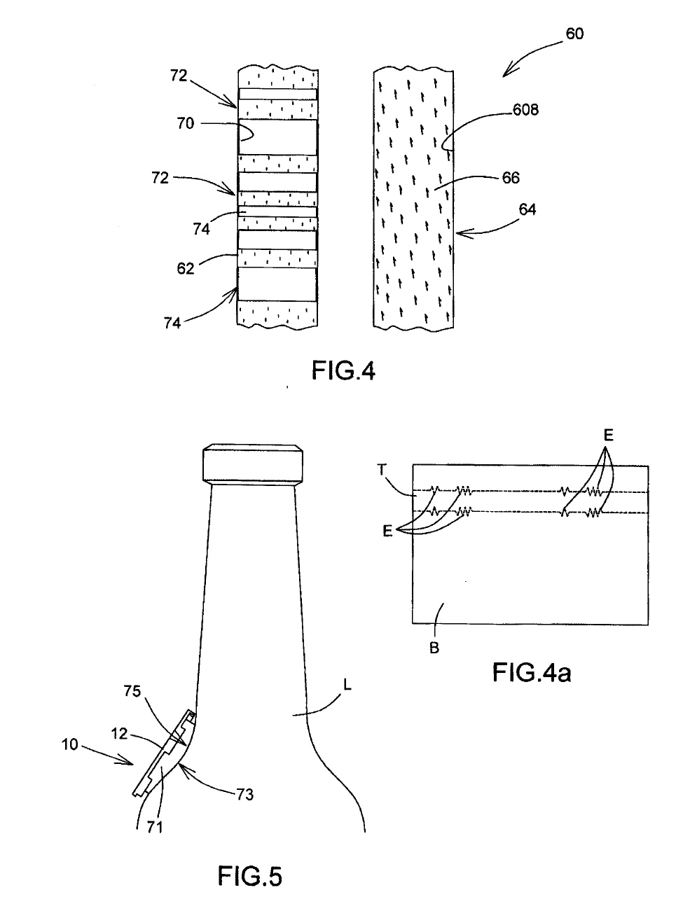

FIG. 4 shows a sound triggering device 60 that is used in conjunction with the sound recognition devices disclosed herein. The device 60 includes a pair of longitudinal strips 62 and 64. Both strips 62 and 64 include hook-and-loop fabric 66 for mutually mating the strips 62 and 604 together when interfacing their respective fabric 66. In one example, the strips 62 and 64 are Velcro™. When separated, the strips 62 and 64 cause a tearing sound, for examples strip 64 comprises a contiguous hook-and-loop fabric 66 on its inner face 68. Strip 62 on the hand includes bar code style design of hook-and-loop fabric with portions of its inner face 70 including zones 72 of fabric 66 fabric interspaced with predetermined empty zones 614. The zones 72 and 74 can be provided in different sizes and positioned so as to provide a distinctive sound when the strips are separated which can be alternated to provide a variety of predetermined distinctive sound that can trigger the sound recognition devices disclosed herein.

The strips 62 and 64 are mounted within the box or package containing the item and mated together. The strips can be mounted about the flaps or any other convenient portion of the box or package to cause the device 60 to produce a distinctive tearing sound that is recognized by the sound recognition device mounted to the box so as to be correspondingly triggered.

In this way, regular Velcro™ cannot be used by the perpetrator externally to activate the sound recognition device and as such confuse the security system. Furthermore, various bar code like configurations can be used so that if a perpetrator obtains one type it does not produce a common tearing sound that can activate any sound recognition device. The bar code design allows alternating the sound produced by device 60.

In another embodiment, the box flap F has a portion or strip with a predetermined cut pattern commonly known as a “tear strip” for being torn off in order to access the internal contents therein. Much like the bar code like configuration of the above strips 62 and 64, this cut pattern makes a distinct sound when removed that is identified by the sound recognition technology discussed herein in order to trigger an alarm during unauthorized tearing. In an embodiment, the controller provides for recognizing approved teat strip sound signatures to be used in conjunction with specified packaging materials so as to produce a distinct sound signature.

FIG. 5 shows a device 10-1 with a base 71 with a non-flat bottom surface 73 shaped to match the surface 75 of a bottle L. As such, a variety of curved bases can be provided for curved surfaces such as bottles, balls and the like. The bases 20, 71 or the bottom surfaces 16 can be molded to be placed onto a variety of curved, jagged or otherwise formed surfaces

In another embodiment, there is provided a theft prevention device for being mounted to a package enclosing an item. This device comprises a light capturing panel (such as a solar panel) for being mounted within the package. An alarm device is in operational communication with the light capturing panel for being activated thereby so as to signal an alarm. When the device is mounted to the package, the light capturing panel provides for capturing light entering the package so as to activate the alarm device to signal the alarm.

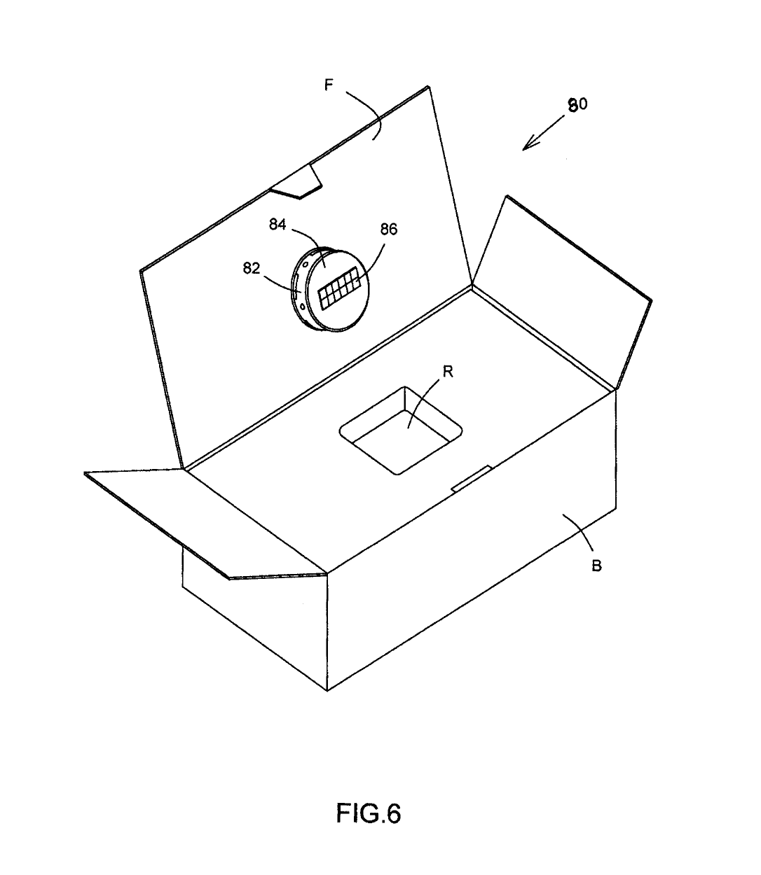

With reference to FIG. 6 a non-limiting example of the above embodiment exemplified as a device 80 will now be described for the purpose of illustration and by no means limitation. Device 80 is mounted within a box B containing an item and comprises a light capturing element, thus when the flap F or other portion of the package B is opened during unauthorized retrieval of the packaged item, light enters the box and activates the device to signal an alarm as previously mentioned. As shown, the box B includes a conveniently recessed portion to provide a clearance for the device 80.

It should be noted that device 80 includes many but not all of the features of device 10 and as such particular attention will be paid to the features of device 60 which are not present in device 10 for concision purposes only.

The device 80 includes a main body 82 housing a control including an alarm system therein and comprising a top face 84 with a light detecting panel 86 in communication with the controller therein. The light detector element 86 is a conventional device as used on calculators and like devices. Once light is captured and as is well known in the art, the electrical current is transferred to a sound generator which signals an alarm.

As with device 10 and device 80, the main body in both devices is securely fastened to its base member and removal is facilitated with the use of removal devices.

In another embodiment, the solar panel is a separate piece that is positioned within the box and in operative communication with the main body which is positioned externally on the box. In one embodiment, the box is punctured allowing for the aforementioned operative communication. In one embodiment, a wire connection is passed through the punctured box or package between the internal solar panel and the external main body. In one embodiment, a puncturing protrusion extends from the main body puncturing the box and the other end of this protrusion is connected to the solar panel and provides for conductive communication between the main body and the solar panel.

In an embodiment, the pin or plunger 48 may be removed from any of devices disclosed herein and as such, apertures and holes for its passage are not needed.

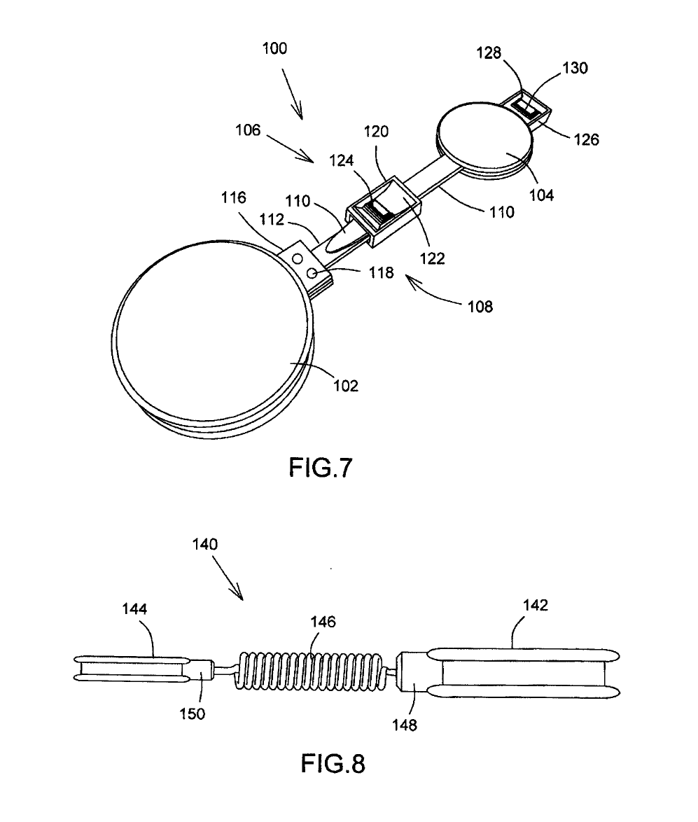

With reference to FIGS. 7, 8, 9, 10 and 11 a variety of internal alarm devices will now be discussed. These alarm devices provide for ringing, sounding or signaling an alarm once a box has been opened. Each device comprises two bodies. A main body triggers the alarm, the other body or auxiliary body is an anchor so mounted within the box and operatively connected to the main body, so that when the flap is opened without authorization, the anchor body is caused to move during the opening process thereby actuating the main body to signal an alarm.

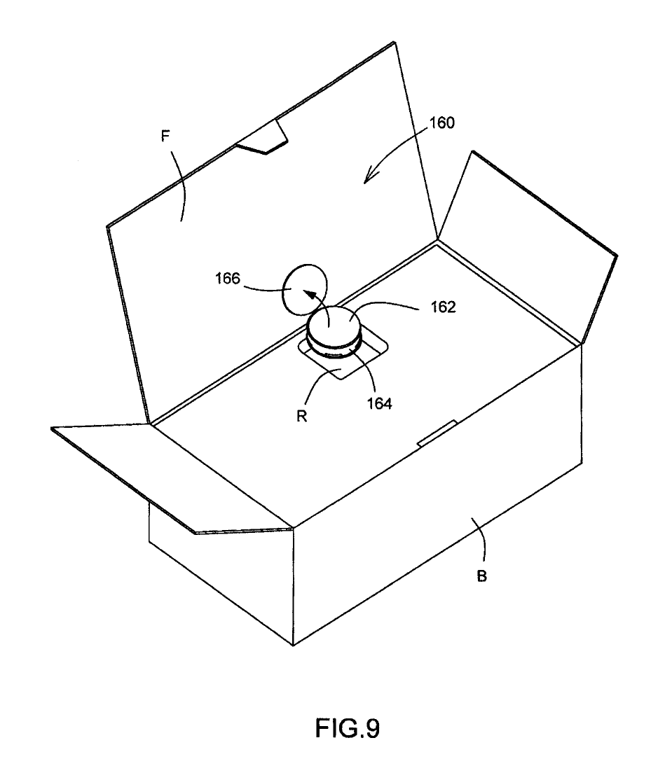

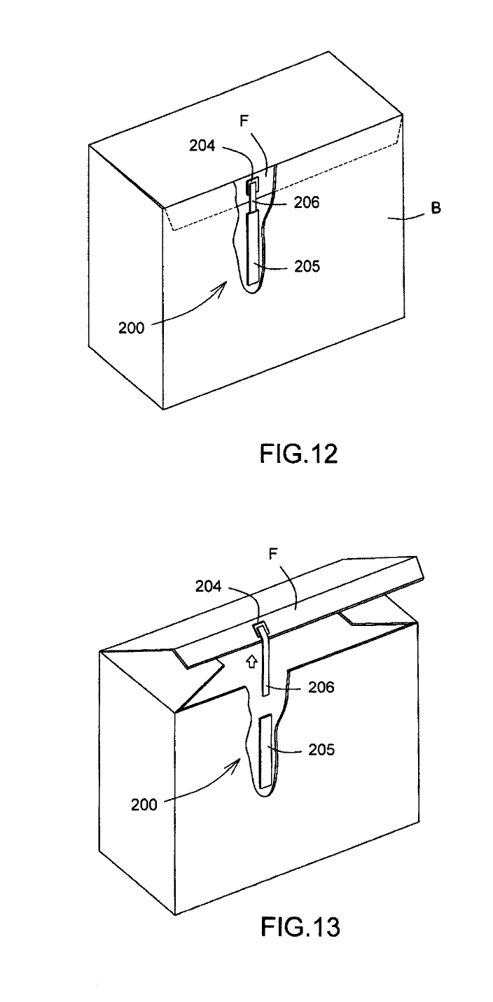

In an embodiment, a theft prevention device is provided for being mounted to a package, such as a box, housing an item and having a closure such as a flap for providing access to the item therein when the closure is in the open position (see FIGS. 9 and 13) and for preventing access to the item therein when the closure is in the closed position (see FIG. 12). The device comprises a body assembly with at least two body members such as a main body and an auxiliary or anchor body to give but one non-restrictive illustrative example. One of these two bodies or body members (these terms are used interchangeably herein) provides for being mounted on an inner side of the closure flap (for example by an adhesive as per the examples discussed below). The other of the two bodies is mounted elsewhere in the box but not on the closure flap as shown in the examples below. In one example, this other body rests on another internal part or portion of the box, in another embodiment it is adhered to an internal part. A trigger and alarm assembly is mounted to the body assembly for signaling an alarm when the two bodies are moved away from one another. The trigger and alarm assembly can include actuation strips, hinges and the like in operational communication with an alarm device via a switch.

The foregoing embodiment will be exemplified for illustrative purposes only in FIGS. 7, 8, 9, 10 and 11.

Turning to FIG. 7, there is shown a device 100 having a main body 102 and a distal auxiliary anchor body 104 with an actuator assembly 106 interposed therebetween. The main body 102 houses a controller for sounding the alarm.

The actuation assembly 106 comprises two portions, 108 and 110 respectively.

Portion 108 comprises a strap element 112 having one end thereof mounted via a channel 114 in a protrusion 116 extending from the main body 102 and secured thereto by screws 118. The strap element 112 carries on the opposite end thereof a plug member 120 for receiving therein the other portion 110 which is in the form of a strap. The strap 110 is releasably fastened within the plug element 120 via a biasing enclosure 122 including a push button 124 that when actuated releases the strap 110. The opposite end of the strap 110 is positioned within the anchor body 104. In one version of device 100, the strap 110 includes holes that receive internal teeth elements of body 104. In the version illustrated here, the distal end of the strap 110 is inserted within a plug element 126 that protrudes from the body 104 and is kept in place by the biasing force of the enclosure 128, said force being released by the actuation of a push button 132.

The main body 102 and auxiliary or anchor body 104 are shown as having two different sizes, in another embodiment, these two bodies are similarly sized. In another embodiment, both bodies 102 and 104 are signaled.

Turning now to FIG. 8, there is shown a device 140 that is similarly configured to device 100 except that the actuation assembly, interconnecting the main body 142 to the auxiliary or anchor body 144 is in this case a single coiled wire 146. Moreover, the main body 142 and the anchor body 144 comprise respective cylindrical protrusions, 148 and 150 for receiving the wire 146. Of course, a non-coiled wire may also be used.

FIG. 9 shows a device 160 mounted to the internal side of a closure or flap F of a package or box B. The device includes a main body 162 mounted via a base 164 to the flap F. An auxiliary body 166 is hinged to the main body 162 conveniently near the common edge between flap F and the rest of the box B. A strap element (not shown) is pulled away from the main body 162 as the auxiliary body 166 is pivoted away from the main body 162. More specifically, the main auxiliary body 166 is anchored to the box B via an adhesive substance. A recess R is conveniently provided within the box B in order to provide clearance for the device 160.

In each case, whether for device 100, 140 or 160, when the trigger element is pulled by the user who moves the flap cover F of a box B this will correspondingly pull the interconnected straps, hinges or wires as described above thereby triggering the alarm systems within the main bodies described above.

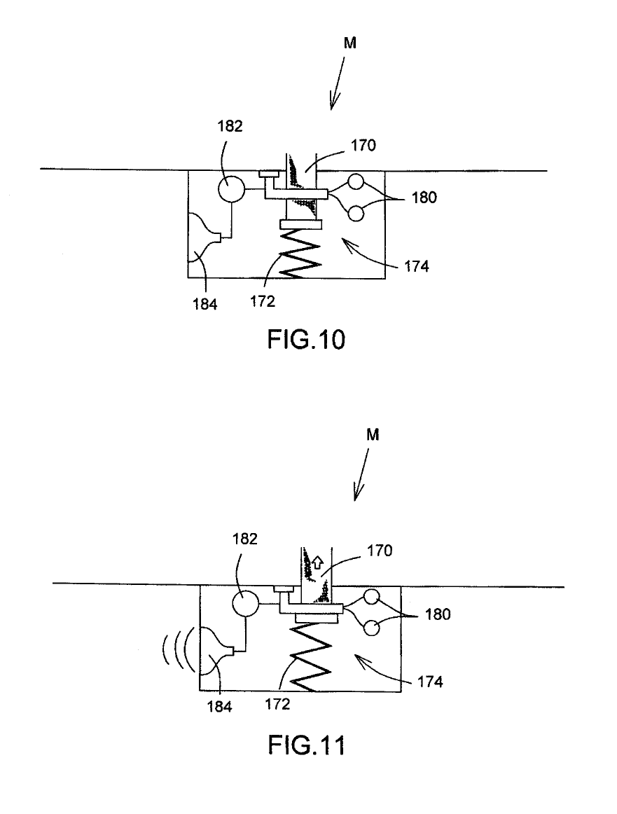

FIGS. 10 and 11 represent the internal contents of a main body, generally denoted M of devices 100, 140 or 160 and similar embodiments.

An internal strap element 170 is caused by the actuation assembly 106, the wire 146 or the strap within the hinged portion between the bodies 162 and 166 of device 160 to move outwardly against a biasing element 172 biasing the strap element 170 inwardly. The strap element 170 closes the switch 174 when moved outwardly of the main body M as shown in FIG. 11. More specifically, the switch 174 includes conductive switch elements 176 and 178. Element 176 is connected to the strap element 170 and biased by the biasing element 172 away from element 178. Element 176 is in communication with a power source 180 such as batteries. As the strap element 170 is moved outwardly, the conductive switch elements 176 and 178 are brought into contact thus providing the power source to activate a sound generator 182 which signals an alarm 184.

The various components can be assembled within the main bodies of the devices described above in a variety of suitable ways as can be contemplated by the skilled artisan.

The present disclosure provides still other internal devices. In an embodiment there is provided a theft prevention assembly comprising a body assembly (such as main body and an auxiliary body) for being mounted within a package housing an item and having a closure for providing access to the item therein when the closure is in the open position and for preventing access to the item therein when the closure is in the closed position. The body assembly comprises two bodies movably interconnected together with one of the bodies being mounted to the closure and the other body being mounted elsewhere within the package. One of the bodies includes a resonating body. An actuator is interposed between the two bodies (or body members) and movably connected to the resonating body for preventing it from resonating when impacted by a radiofrequency. The theft prevention assembly also includes an RF device for emitting a radiofrequency that impacts the resonating body. As such, when this theft prevention assembly is use the radiofrequency impacts the resonating body and when the closure is opened the actuator moves away from the resonating body allowing it to be resonated by the impacting radiofrequency so as to produce a radiofrequency that is indicative of unauthorized access into the package.

With reference to FIGS. 12 to 15, an illustrative example of the above theft prevention assembly will now be described.

FIGS. 26 and 27 show a box B in broken form so as to reveal the internal contents thereof carrying a trigger device 200. The trigger device 200 comprises a resonating body 202 mounted within the inner side of the box as well as an anchor body 204 mounted within the flap F and an actuator 206 therebetween. Bodies 202 and 204 are pair of tags or strips, and the actuator 206 is also an elongated strip of material. In one embodiment, the strip 206 comprises a convenient material that cannot be easily cut. Body 202 includes elongated acoustic blades therein (not illustrated yet well known in the art) separated by the strip 206.

A device 10-2 used in conjunction with trigger device 200 comprises a main body 12-2 and a base 208. The main body 12-2 includes at its underside 16 an antenna connector 210 which mates with, when the main body 12-2 is snapped onto the base 208, a corresponding antenna connector 212 on the inner surface 214 of the base 208 that is contiguous to a circular antenna 216.

The controller within the main body 12-2 emits, via connections between connectors 210 and 210 and the antenna 210 a frequency within a predetermined range that impacts the acoustic blades within the tag body 202.

Once a perpetrator opens the flap F, the separator strip 206 is removed from the resonating body 202 since the separator strip 206 is anchored to the anchor body 204. Thus, with the separator strip 426 removed, the acoustic blades are caused to resonate with each other due to the emitted radio frequencies sounding off an alarm.

It should be noted that the antenna need not be a large circular antenna and that even a small frequency emission area may be adequate. In another embodiment, the circular antenna can be replaced by short wire or stem (not illustrated) inside the base 208 itself. This is useful for smaller boxes whereas antenna 216 is useful for much larger boxes. In another embodiment, an EAS transceiver is equipped within the device.

In an embodiment, the device 10-2 can be mounted to strategic areas within the premises where the items are stored, such as shelves, walls and the like so as to cause various trigger devices 200 to resonate and sound an alarm if the packages are accessed without authorization.

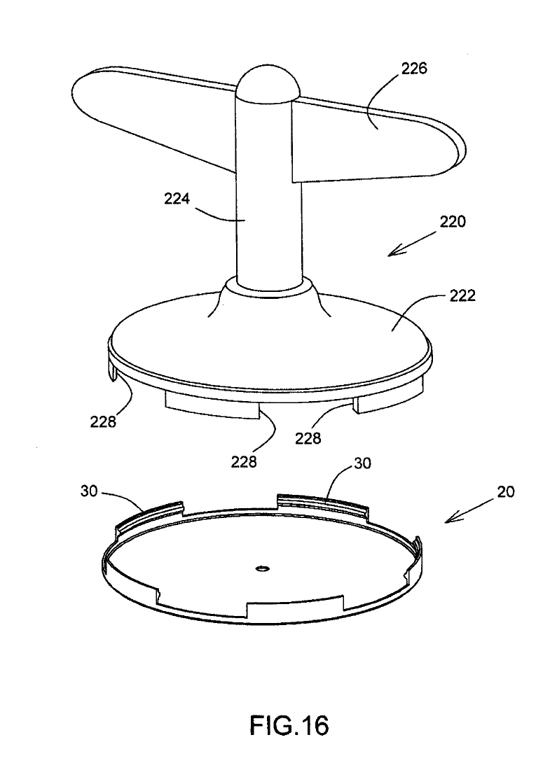

Turning now to FIG. 16 a removal device 220 will now be described. The removal device is useful when the base 20 does not include a tab 23 as described above

The device 220 comprises a base element 222, a longitudinal stem 224 and handles 226.

The base 222 includes a plurality of teeth elements 228 which mesh or interfere with the teeth elements 30 of the base 20. The user twists the stem 224 via handle 226 thereby turning the body 222 and as such, the teeth members 228 will interact with teeth members 30 twisting the base 20 off the box it is mounted to.

FIG. 17 shows a security or theft prevention management system 230 comprising a main remote controller 232, such as a computer, in communication with a plurality of on-site controllers 234, such as a computer. Each on site controller 234 is within the environment that one or more of the devices D described herein are in operation. The on-site controllers 234 can also be in communication with handheld units H, such as handheld computers that are carried by security personnel within the stores. The handheld units receive information from the devices D. For example, before sounding off an alarm, a warning signal is sent to the handheld unit H, warning the security staff that there is a potential danger in a certain zone. This same warning signal can be sent to the on-site controller 234 which can either transfer this information to the handheld unit or to a motion capture device or camera to take a close-up video of a given zone within the store.

All the information amassed by the on-site controllers is communicated to the main controller 232 which can provide reports based on the statistics it collects or even provide suggestions for security improvements or store operations. This information can also gather valuable management data for example, the number of times a customer stands in front or an item, or picks up an item (via a motion sensor, a motion capture device, a camera and the like), including time frames of such events and the like. Moreover, and as will be discussed below, the main controller can also receive new sound signatures that were recorded by various users which can be uploaded via the internet to be downloaded by other users and added onto the controller. Uploading can be done during the learning mode or intelligent mode as previously described. Over time a community of users are provided to build an internet accessible database of sound signatures.

As mentioned above, in a particular illustrative embodiment, the theft prevention device uses sound recognition technology to detect tampering with the packaging. The theft prevention device is configured to recognize certain predetermined sounds (referred to herein as “trigger sounds”). Once a match is made, an associated alarm is signaled. For example, in one embodiment a database comprises pre-recorded sounds such as: opening of a packaging; unwrapping of cellophane used in wrapping items like perfume packaging; cutting open a packaging; dangling of keys (packaging cutters are often found on key chains); muffling of device; voice recognition (for recognizing words such as “stealing” “lifting”, “let's go”, “watch it”, “hurry up”, etc.). The alarm only triggers once the sound is recognized. In some instances the sound must be recognized for a certain length of time and/or a number of times during a given time period to activate an alarm.

In one embodiment, the theft prevention device may be provided with specially designed packaging having specific trigger sound signals. This increases the precision with regards to detection and accuracy reading of the theft prevention device and reduces the number of false alarms. For example and as previously discussed, the packaging may include a Velcro™ strip inside, for example between the lip of the cover flap and main packaging body so that when the lip is opened the strips are detached making a tearing sound that is captured by the theft prevention device, which can be configured to recognized thousands of Velcro™ tearing sound signals or other type of hook-and-loop fabric.

In another embodiment the hook-and-loop device includes two strips of Velcro™ on with the hook-and-loop fabric formed thereon in a contiguous fashion the other with predetermined empty zones to provide a distinctive predetermined trigger sound signal.

In a further embodiment, the specially designed packaging may be provided with a specially designed tear-strip that emits a distinctive sound signal that can easily be detected by the theft prevention device 300 and not be mistaken with other ambient sounds. The foregoing is exemplified in FIG. 4A which shows a box B having a tear-strip T with a specially cut pattern E that produces a distinctive sound signal based on the material of the box B, the tear-strip T and the cut pattern E. A variety of materials and configurations (e.g. corrugated cardboard boxes) provide distinct sound signals.

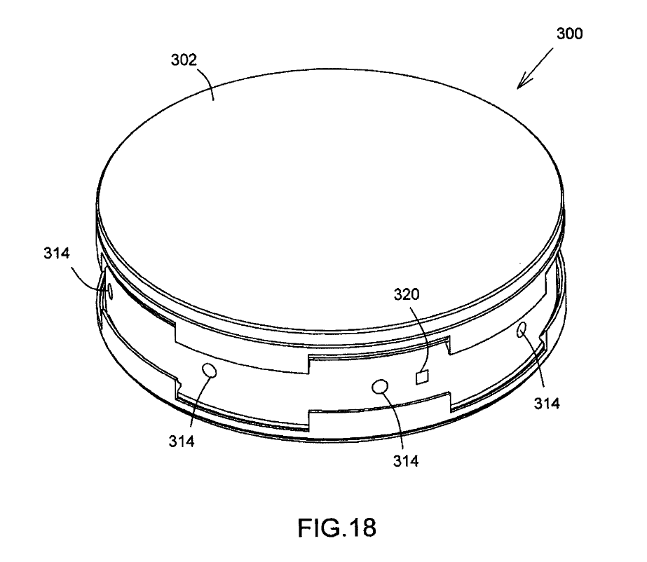

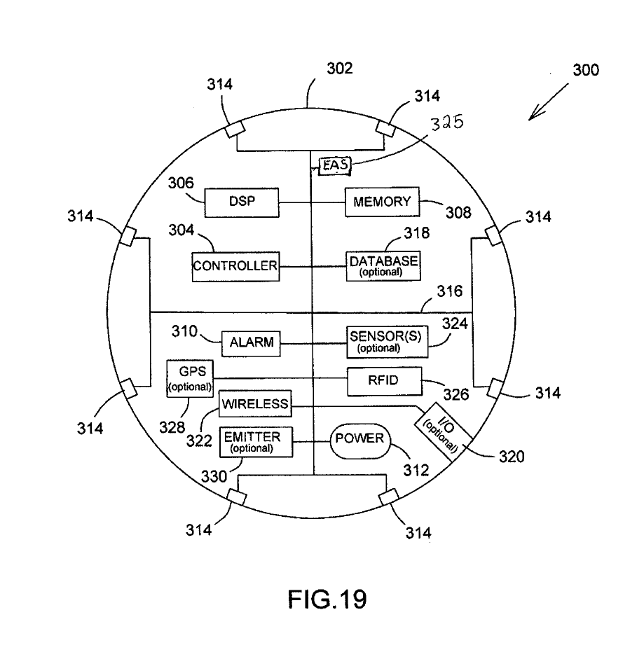

In the illustrative non-restrictive embodiment shown in FIGS. 18 and 19, the theft prevention device 300 includes a housing (or main body) 302 which houses a controller 304, a digital signal processor (DSP) 306, a memory 308, an alarm mechanism 310, a power supply 312, a circular array of microphones 314, a wireless communication interface 322 and a radio frequency identification (RFID) 326, all of the components communicating via a communication and power bus 316. Of course, as is known in the art, the device includes an EAS component 325. The device can also include an RF transmitter.

Optionally, in alternative embodiments of the theft prevention device 300, the housing 302 may further include components such as a database 318, an input/output (I/O) interface 320, one or more sensors 324, a global positioning system (GPS) 328 and an emitter 330. In one embodiment, the DSP 306 may have an associated a spectrum analyzer as is known in the art.

In other embodiment, the DSP 306 includes other devices such as a mercury switch, dB level analyzer, a real time analyzer and the like.

The controller 304 controls the operations of the various components of the theft prevention device 300. Its operations will be further explained below. In an alternative embodiment, the controller 304 may provide a remote device or system with statistics with regard to the operations of the theft prevention device 300, for example warnings that have been generated, with the times at which they were generated, etc.

The DSP 306 is used by the controller 304 to analyze the sound signals provided by the microphones 314. It compares a recorded signal to known trigger sound signals stored, for example, in the memory 308 or optionally in the database 318. The DSP 306 then provides a rating of the match between the recorded sound signal and the known trigger sound signals to the controller 304. It is to be understood that the trigger sound signals may also comprise specific audio signal patterns of varying duration, frequency and amplitude. It is further to be understood that sound signals may also include the human voice.

The memory 308 stores processes used by the controller 304 to control the various components of the theft prevention device 300, for example drivers/protocols for various interfaces such as the I/O interface 302 or the wireless interface 322, procedures such as learning procedures (e.g. “normal ambient sound detection”), etc. It can also store known trigger sound signals for use by the DSP 306. The memory 308 may also be used by the controller 304 to store operational statistics of the theft prevention device 300.

The alarm 310 is triggered by the controller 304 when packaging tampering is detected. The alarm 310 consists of a sound generator that may be combined with a visual display as well (e.g. a red blinking light, such as element 7 described above). The triggering of the alarm 310 by the controller 304 will be further explained below. The alarm 310 can also be used to generate a warning when trigger sound signals are identified but below a certain certainty threshold.

The power supply 312 provides power to the various components of the theft prevention device 300 and may be in the form, for example, of a lithium battery.

The microphones 314, numbering eight in the illustrative embodiment, are equally spaced apart disposed in a circular array or a closed loop along the circular periphery of the housing 302. This configuration is convenient when the perpetrator tries to cut the box around the device 300. They provide audio signals of the surrounding environment of the theft prevention device 300 to the DSP 306.

The communication and power bus 316 allows communication between all of the components of the theft prevention device 300 as well as providing them with power from the power supply 312. It is to be understood, however, that communication and power may be transmitted on separate busses.

The optional database 318 can be used to store known trigger sound signals for use by the DSP 306. Furthermore, it may also be used to store ambient sound signals in order to improve the precision of the DSP 306 in identifying trigger sound signals by allowing it to filter out expected sounds from the theft prevention device 300 environment. It should be noted that an absence of at least certain ambient sounds is an indication of muffling. These ambient sound signals may be recorded by the theft prevention device 300 at various time intervals and stored (e.g. learning mode) after a similar sound signal has been identified for a predetermined number of instances. The database 318 can hold thousands of ambient sound signals and trigger sound signals relating to the opening of numerous and various kinds packages. The sounds signals may further classified as generating alarms and/or warnings bases.

The optional I/O interface 320 can be used to set various parameters of the theft prevention device 300 such as, for example, sound threshold levels, which are stored in the memory 308. It can also be used to download new trigger sound signals and/or ambient sounds to the database 318 from a remote device or system, or upload trigger sound signals and/or ambient sounds from the database 318 to such remote device or system. The optional I/O interface 320 may also be used by the controller 304 to provide a remote device or system with statistics with regard to the operations of the theft prevention device 300, for example warnings that have been generated, with the times at which they were generated, etc.

Sound signals uploaded to a remote device or system may be analyzed and if determined as reliable, made available for download by other theft prevention devices 300. The determination of the reliability of a given uploaded sound signal may be effectuated by, for example, matching it with a given number of other uploaded sound signals, for instance with more than 100 other such sound signals.

Sound signals download and upload can be performed through, for example, the Internet, Wi-Fi, Cloud Synchronization, etc.

The wireless interface 322 is used to activate and deactivate the theft prevention device 300, or put it in a sleep or a pause state having a configurable time duration. It is to be understood that communications via the wireless interface 322 may be encrypted or otherwise protected. The wireless interface 322 may optionally be further configured to fulfill functionalities similar to that of the optional I/O interface 320. It may further be used to transmit an alarm condition to a remote device or system.

The optional sensors 324 may include one or more sensors such as, for example, a motion sensor, an infrared (IR) proximity sensor, metal detector, acoustic/echo locator.

The RFID 326 is used, as is known in the art, to transmit a signal to a remote receiver which will produce an alarm condition and, optionally, produce encoded product information if the theft prevention device 300 is removed from a designated zone without authorization.

The optional GPS 328 may be used to determine the location of the theft prevention device 300, inside or outside an establishment, at any given time and/or trigger the alarm 310 if the theft prevention device 300 is removed from a designated zone without authorization.

The optional emitter 330 may be used by the DSP 306 to detect sound muffling or sound muffling attempts. This may be accomplished by listening to the ambient sounds by sending out several sound pulses via optional emitter 330 over a predetermined period of time, for example milliseconds. This may be initiated at given time intervals or whenever the DSP 306 detects that the ambient noise level is below a certain threshold. For example, when a potential thief covers the device with aluminum foil or their hand, the ambient noise level will change drastically so that the theft prevention device 300 will recognize that ambient sounds are no longer present. A sensitivity setting allows a user to set the ambient sounds level threshold required to trigger the alarm 310.

It is to be understood that although the illustrative embodiment comprises height microphones 314 equally spaced apart disposed in a circular array along the circular periphery of the housing 302, the number of microphones 314, their disposition and the shape of the housing 302 may vary.

In an alternative embodiment, the theft prevention device 300 may be configured so as to identify ultrasounds or intrasounds or infrasounds which are emitted by devices inside the packaging if unauthorized entry is attempted. The ultrasounds or intrasounds may be establishment specific to foil ultrasounds or intrasounds or infrasounds scrambling attempts.

In a further alternative embodiment, theft prevention device 300 may be configured to detect attempts at cutting around the device to remove it from the packaging before trying to open it to steal the contents therein. This can be initiated by detecting a given sound signal pattern having an amplitude above a configurable threshold being detected at a first microphone 314 and below the configurable level at the other microphones 314. The theft prevention device 300 then verifies, over a configurable time period, if this occurs for a second microphone 314 adjacent the first microphone and then with a third microphone 314 adjacent the second microphone 314. If this occurs, the theft prevention device 300 may generate a warning or an alarm, depending on the operating parameters of the theft prevention device 300. Alternatively, if the sensor(s) 324 include a metal detector (or an object recognition device such as a camera or a motion capture device), it may be used to detect the presence of box cutters, keys and other sharp metal objects that may be used to cut open boxes/packages and generate a warning or an alarm.

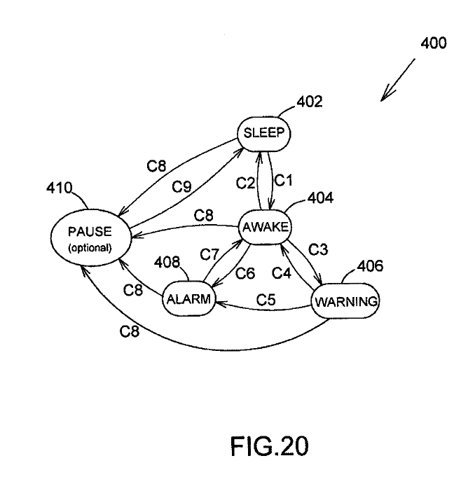

Referring now to FIG. 20, there is shown an example of a states diagram of the operational states 400 of the theft prevention device 300. The states of the states diagram 400 are indicated by numerals 402 to 410 and the state change conditions by numerals C1 to C9.

Initially, once activated, the theft prevention device 300 is in the SLEEP state 402 with minimal functionalities, most components being powered down in order to conserve energy from the power supply 312. Minimal functionalities may include the controller 304 monitoring one or more microphones 314, a sensor 324 such as a motion sensor, an IR sensor, a proximity sensor and acoustic/echo locator (in combination with the optional emitter 330), and the wireless interface 322.

In the SLEEP state 402, the controller 304 continuously verifies if state change condition C1 is present, if so it proceeds to the AWAKE state 404, if not it remains in the SLEEP state 402.

State change condition C1 can include the identification of any indicator of activity near the theft prevention device 300. This is accomplished by monitoring one or more components of the theft prevention device 300 depending on which components are present. For example, state change condition C1 can include a microphone 314 providing a sound signal above a certain configurable activation dB level threshold, a signal from a sensor 324 such as a movement sensor indicating that the theft prevention device 300 has been moved or an IR sensor, a proximity sensor or an acoustic/echo locator sensor indicating that someone is approaching the theft prevention device 300. It is to be understood that state change condition C1 depends on the sensor(s) 324 present in the theft prevention device 300 and that state change condition C1 can include signals from one or more of the sensors 324 present as well as from one or more of the microphones 314.

In an another embodiment, state change condition C1 may include signals from a remote sensor provided via the wireless interface 322, for example a remote system with a motion capture device that can determining the presence and in certain instances the distance between a person and the theft prevention device 300.

State change condition C1 can also include a signal from a remote control via the wireless interface 322 to force the theft prevention device 300 into the AWAKE state 404. They state change condition C1 can also include a configurable timer for initiating an ambient sound signals gathering process as previously described to improve the precision of the DSP 306 in identifying trigger sound signals.

In the WAKE state 404, the controller 304 powers up all of the components of the theft prevention device 300 and proceeds with normal operations. For example, the DSP 306 analyzes sound signals from the microphones 314 and provides ratings of the match between the recorded sound signals and known trigger sound signals to the controller 304. The controller 304 then determines, depending on configurable warning and alarm activation thresholds, if a warning should be initiated (state change condition C3), in which case it proceeds to the WARNING state 406, or if an alarm should be initiated (state change condition C6), in which case it proceeds to the ALARM state 408.

An example of a rating of the match between the recorded sound signal from the microphones 314 and the known trigger sound signals stored in the memory 308 and/or database 318 by the DSP 306 can take the following form:

0-25% match=Poor

26%-50% match=Fairly Poor

51%-75% match=Good

75%-90% match=Very Good

90%-100% match=Excellent

In a first example, state change condition C3 may be a rating of Fairly Poor or Good while state change condition C6 may be a rating of Very Good or Excellent.

In a second example, state change condition C3 may be set to a rating of Good or Very Good while state change condition C6 may be set to a rating of Excellent.

In a third example, state change conditions C3 and C6 may include time duration of the matched sound signals or the number of times the sound signals were matched in a given time period, thus state change condition C3 may be a matching rate of Very Good or Excellent between four and seven times during a time period of two seconds while state change condition C6 may be a matching rate of Very Good or Excellent eight or more times during a time period of two seconds.

In a fourth example, state change conditions C3 and C6 may include the detection of attempts at cutting around the device to remove it from the packaging as previously described.

It is to be understood that state change conditions C3 and C6 may be configurable. It is further to be understood that other rating schemes may also be used.

The controller 304 returns to the SLEEP state 402 if state change condition C2 is present, for example if state change conditions C3 and C6 are not present after a configurable time period.

In the WARNING state 406, the controller 304 activates the alarm 310 in such a manner as to generate a warning audio signal, for example a series of beeps, until the presence of either one of state change conditions C4, changing the state of the theft prevention device 300 back to the AWAKE state 404, or C5, changing the state of the theft prevention device 300 to the ALARM state 408. State change condition C4 may be, for example, a configurable time period or a signal from a remote control via the wireless interface 322 to force the theft prevention device 300 into the AWAKE state 410. As for state change condition C5, it may be, for example, a continuation of state change condition C3 for a configurable time period or the same state change condition as state change condition C6.

In the ALARM state 408, the controller 304 activates the alarm 310 until state change condition C7 is present, changing the state of the theft prevention device 300 back to the AWAKE state 404, for example after a configurable time period or a signal from a remote control via the wireless interface 322 to force the theft prevention device 300 into the AWAKE state 410.

Finally, the PAUSE state 410 can be attained from any of the other states 402, 404, 406 and 408 via state change condition C8, for example a signal from a remote control via the wireless interface 322 to force the theft prevention device 300 into the PAUSE state 410. In the PAUSE state 410 the theft prevention device 300 disables its alarm 310 in order to allow manipulation of the packaging protected by the theft prevention device 300 until the state change condition C9 is present. State change condition C9 may include a configurable time duration and/or a signal from a remote control via the wireless interface 322.

In an alternative embodiment, theft prevention device 300 may be positioned on a shelf, wall, ceiling, or other such installation or architectural feature in order to protect one or more packaged item in the vicinity of the theft prevention device 300. It is to be understood that in this embodiment some components, for example the RFID 326 may be omitted. Furthermore, the state change conditions may also be modified to account for the static positioning of the theft prevention device 300, for example if a motion sensor 324 is present, detection of the movement of may initiate an alarm instead of a warning since the theft prevention device 300 should not me moved. Also, the power supply 312 may be replaced with an AC to DC converter with an electrical cord to connect to a power outlet.

The devices herein have been shown with generally circular configurations, it is to be understood that any other suitable or desirable configuration can also be provided within the scope of the present disclosure including without limitation rectangular, triangular, trapezoidal, tubular structures and the like.

The various features described herein can be combined in a variety of ways within the context of the present disclosure so as to provide still other embodiments. As such, the embodiments are not mutually exclusive. Moreover, the embodiments discussed herein need not include all of the features and elements illustrated and/or described and thus partial combinations of features can also be contemplated. Furthermore, embodiments with less features than those described can also be contemplated. It is to be understood that the present disclosure is not limited in its application to the details of construction and parts illustrated in the accompanying drawings and described hereinabove. The disclosure is capable of other embodiments and of being practiced in various ways. It is also to be understood that the phraseology or terminology used herein is for the purpose of description and not limitation. Hence, although the present disclosure has been provided hereinabove by way of non-restrictive illustrative embodiments thereof, it can be modified, without departing from the scope, spirit and nature thereof and of the appended claims.

1-60. (canceled)

61. A theft prevention device for being mounted to an external surface of a package enclosing an item therein, the device comprising:
a main body having a generally flat undersurface for being mounted directly on the outer surface of the package;
a light capturing panel mounted to the underside of the main body; and
an alarm device housed within said main body in operational communication with said light capturing panel for being activated thereby so as to signal an alarm,
wherein when said device is mounted to a package, said light capturing panel provides for capturing light when the device is removed from the outer surface of the package so as to activate said alarm device to signal the alarm.

62-65. (canceled)

66. A theft prevention device according to claim 61, further comprising:
a controller for identifying at least one predetermined sound signal indicative of unauthorized access into the package,
at least one microphone in communication with said controller for capturing ambient sound and providing a sound signal indicative of the ambient sound to said controller, and
an alarm device in communication with said controller for being controlled thereby,
wherein said controller provides for: (i) comparing the sound signal indicative of the ambient sound with the sound signal indicative of unauthorized access into the package, (ii) identifying a match in (i), and (iii) activating said alarm device to signal an alarm associated with said match.

67. A theft prevention device according to claim 61, further comprising an additional device selected from the group consisting of an EAS component, an RFID component, a GPS, an emitted, a sensor, a spectrum analyzer, and any combination thereof.

68-87. (canceled)

88. A device according to claim 61, wherein the package comprises an opening for exposing the item therein, wherein the panel at least partially covers the opening when the device is mounted on the outer surface of the package.
